(19) United States
(12) Patent Application Publication
(10) Pub. No.: US 2025/0367847 A1
(43) Pub. Date: Dec. 4, 2025

(54) CHAINSAW GUIDE BAR

(71) Applicant: Oregon Tool, Inc., Portland, OR (US)

(72) Inventors: Sebastian Peters, Gresham, OR (US); Monty Lightner, Milwaukie, OR (US)

(73) Assignee: Oregon Tool, Inc., Portland, OR (US)

(21) Appl. No.: 19/219,279

(22) Filed: May 27, 2025

Related U.S. Application Data
(60) Provisional application No. 63/655,812, filed on Jun. 4, 2024.

(51) Int. Cl. B27B 17/02

(52) U.S. Cl. CPC B27B 17/025

(57) ABSTRACT

A guide bar for a chain saw includes a bar member manufactured from a first metal material and having a wall defining a space in the bar member. A portion of the wall protrudes into the space. The guide bar also includes an insert manufactured from a second metal material. The insert is mechanically retained within the space and by engagement between the insert and the portion of the wall protruding into the space.

### CROSS-REFERENCE TO RELATED APPLICATION

This application claims the benefit of and priority to U.S. Provisional Patent Application No. 63/655,812 filed Jun. 4, 2024, the entire disclosure of which is incorporated by reference herein.

### BACKGROUND

The present disclosure relates generally to chainsaws, in particular to guide bars for chainsaws. In use, a guide bar is subjected to extensive vibrations, bending, setback events, and forceful contact with objects and materials (e.g., wood, plant matter, concrete, etc.) being cut by chainsaws, such that the guide bar will degrade over time and can benefit from structural strength and rigidity. Structural strength allows the saw to cut in straight lines. Guide bars are therefore often be formed from steel which may be heavy for a user. Heavy chainsaw bars can fatigue the operators, and can make it more difficult for the user to use the chainsaw for an extended period of time.

### SUMMARY

One implementation of the present disclosure is a guide bar for a chain saw. The guide bar for a chain saw includes a bar member manufactured from a first metal material and having a wall defining a space in the bar member. A portion of the wall protrudes into the space. The guide bar also includes an insert manufactured from a second metal material. The insert is mechanically retained within the space and by engagement between the insert and the portion of the wall protruding into the space.

Another implementation of the present disclosure is a chainsaw including a body including a motor, a chain configured to be driven by the motor, and a bar coupled with the body and configured to receive the chain about an outer periphery of the bar. The bar includes a body member manufactured from steel. The body member includes a space that differs in size at different depths into the body member. The bar also includes an insert manufactured from aluminum, the insert positioned in the space such that the insert substantially fills the space and is mechanically retained in the body member.

Another implementation of the present disclosure is a method of manufacturing a bar for a chainsaw. The method includes milling a space in a bar member of a first metal material such that a portion of a wall defining the space in the bar member protrudes into the space. The method also includes inserting an insert of a second metal material into space in the bar member and retaining the insert in the space by deforming the insert to cause the insert to engage the portion of the wall protruding into the space.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a chainsaw having a guide bar, according to some embodiments.

FIG. 2 is a first side view of the guide bar of FIG. 1, according to some embodiments.

FIG. 3 is a second side view of the guide bar of FIG. 1, according to some embodiments.

FIG. 4 is an exploded perspective view of the guide bar of FIG. 1, according to some embodiments.

FIG. 5A is a sectional view of the guide bar of FIG. 1 with an insert installed, according to some embodiments.

FIG. 5B is another sectional view of the guide bar of FIG. 1 without the insert installed, according to some embodiments.

FIG. 6 is a perspective view of the guide bar of FIG. 1 from the first side, according to some embodiments.

FIG. 7 is a perspective view of the guide bar of FIG. 1 from the second side, according to some embodiments.

FIG. 8 is a perspective sectional view of the guide bar of FIG. 1, according to some embodiments.

FIG. 9 is a diagram of a friction stir extrusion manufacturing process for the guide bar of FIG. 1, according to some embodiments.

FIG. 10 is another diagram of the friction stir extrusion manufacturing process for the guide bar of FIG. 1, according to some embodiments.

FIG. 11 is another diagram of the friction stir extrusion manufacturing process for the guide bar of FIG. 1, according to some embodiments.

FIG. 12 is a side view of the insert of the guide bar of FIG. 1, illustrating a manufacturing process of the insert, according to some embodiments.

FIG. 13 is a flow diagram of a process for manufacturing the guide bar of FIG. 1, according to some embodiments.

FIG. 14 is a side view of a first alternative embodiment of the guide bar of FIGS. 2-12 in a disassembled state, according to some embodiments.

FIG. 15 is a side view of the first alternative embodiment of FIG. 14 in an assembled state, according to some embodiments.

FIG. 16 is a side view of a second alternative embodiment of the guide bar of FIGS. 2-12 in a disassembled state, according to some embodiments.

FIG. 17 is a side view of the second alternative embodiment of the guide bar of FIG. 16 in an assembled state, according to some embodiments.

FIG. 18 is a first set of side views of various alternative embodiments of the guide bar of FIGS. 2-12, according to some embodiments

FIG. 19 is a second set of side views of various alternative embodiments of the guide bar of FIGS. 2-12, according to some embodiments.

FIG. 20 is a cross-sectional end or top view of formation of a guide bar, according to some embodiments.

FIG. 21 is a perspective view of a portion of the guide bar of FIG. 20 before crushing of an insert, according to some embodiments.

FIG. 22 is an view of an insert for a guide bar and a bar member of the guide bar, according to some embodiments.

FIG. 23 is an illustration relating to crushing of an insert into a space in a bar member of a guide bar, according to some embodiments.

FIG. 24 is a set of cross-sectional views of a guide bar, according to some embodiments.

FIG. 25 includes views of a guide bar, according to some embodiments.

FIG. 26 is an exploded view of the guide bar of FIG. 25, according to some embodiments.

FIG. 27 is a cross-section view of the guide bar of FIG. 25 prior to deformation of an insert of the guide bar, according to some embodiments.

FIG. 28 is an illustration of crushing or pressing to deform the insert, according to some embodiments.

FIG. 29 is a cross-section view of the guide bar of FIG. 25, according to some embodiments.

FIG. 30 is another cross-section view of a guide bar, according to some embodiments.

FIG. 31 is another cross-section view of a guide bar, according to some embodiments.

FIG. 32 is another cross-section view of a guide bar, according to some embodiments.

FIG. 33 is another cross-section view of a guide bar, according to some embodiments.

FIG. 34 is another cross-section view of a guide bar, according to some embodiments.

### DETAILED DESCRIPTION

Referring generally to the figures, a guide bar for a chainsaw includes a steel body and at least one aluminum insert. The steel body and the aluminum insert(s) may be mechanically coupled with each other and can provide a lightweight but resilient and robust guide bar. Reducing the weight of the guide bar by replacing portions of the steel body with aluminum improves usability of the chainsaw for a user. In the guide bars herein, at least one aluminum insert is mechanically retained in a space in the steel body, for example by engaging a portion of a steel body extending into the space (e.g., a dove-tail shape, a protrusion centrally located along a thickness of the steel body, etc.). Such mechanical retention can be achieved by deforming the insert to substantially fill the space in the body, for example by crushing (e.g., via pressing, rolling, hammering, etc.) the insert and/or via friction stir extrusion. The resulting guide bar advantageously is a true solid bar (e.g., a true solid metal bar) without any substantial voids or hollow sections provided to reduce weight. The aluminum insert(s) substantially fill the space(s) in the steel body. Together, the aluminum insert and the steel body can withstand various temperature extremes and forces, torques, etc., by virtue of being mechanically bonded without using chemicals or adhesives. This approach improves rigidity, reliability, durability, etc. of the guide bar relative to other potential approaches for providing lightweight guide bars.

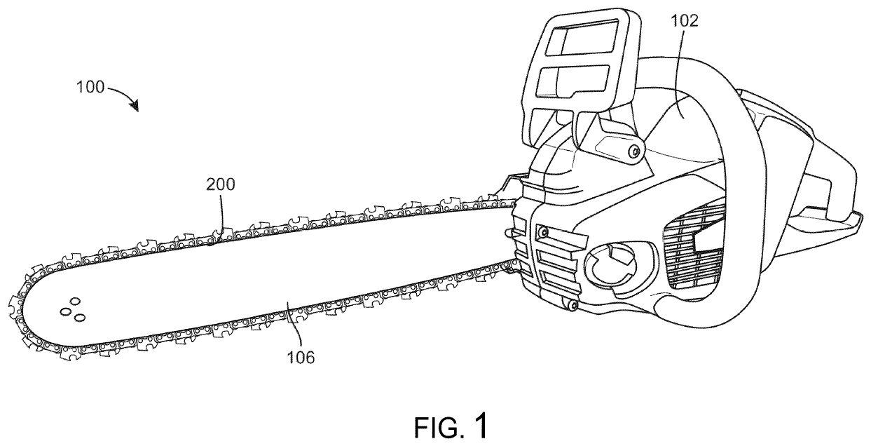

Referring now to FIG. 1, a chainsaw 100 is shown, according to some embodiments. The chainsaw 100 includes a body 102, a guide bar 200 coupled to the body and extending from the body 102, and a saw chain coupled to the guide bar 200 and extending along a periphery of the guide bar 200 (e.g., in a closed loop). The body 102 includes a motor (e.g., combustion engine, electric motor) operable to drive the saw chain 106 along the guide bar 200, such that the saw chain 106 rotates around the guide bar 200 during operation of the chainsaw 100.

The saw chain 106 includes cutting links, sharp portions, etc. such that, when driven to rotate around the guide bar 200, the saw chain can cut into, through, etc. external objects, materials etc. During execution of cuts using the chainsaw 100, some or all of the guide bar 200 will be disposed within an object being cut (e.g., a log, etc.) and as a result, the guide bar 200 will typically be scraped, scratched, scuffed, etc. by interaction with the object being cut.

The guide bar 200 and the saw chain 106 are detachable from the body 102 of the chainsaw 100. The guide bar 200 and the saw chain 106 can thus be selectively removed from the body 102 of the chain saw and replaced with new instances of the guide bar 200 and/or the saw chain 106. Because the guide bar 200 and the saw chain 106 experience significantly more wear than the body 102, the life of the chainsaw 100 can be significantly expanded by periodically removing and replacing the guide bar 200 and/or the saw chain 106 with a new guide bar and/or new saw chain (at the same time, on different schedules, etc.). The body 102 is compatible with a limited set of guide bar sizes, configurations, types, etc., such that successfully replacing the guide bar 200 and/or the saw chain 106 benefits from product information about the guide bar 200, for example a guide bar 200 as originally installed and sold by the manufacturer of the chain saw 106 and/or previously installed and/or used by a user of the chain saw 106.

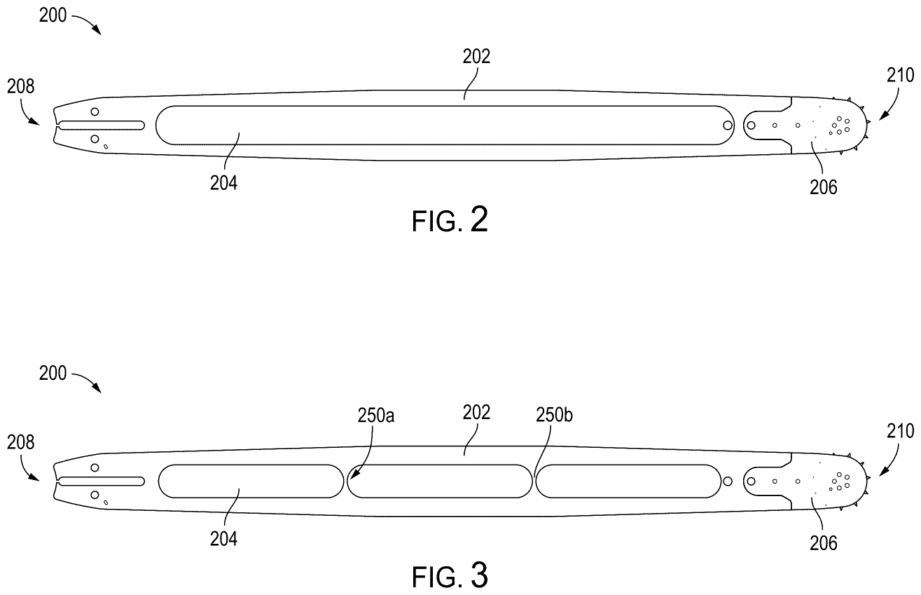

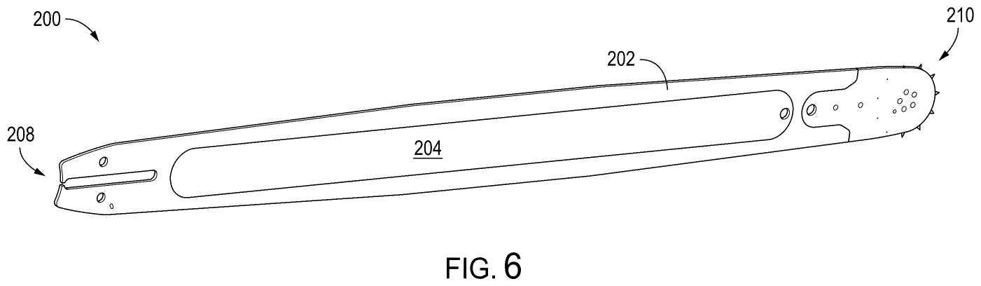

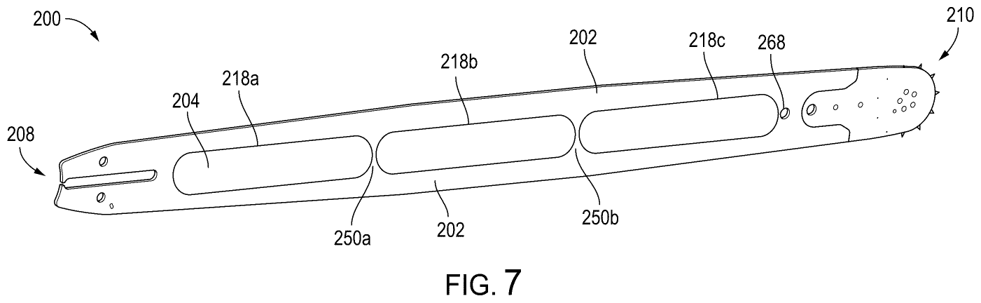

Referring to FIGS. 2-8, the guide bar 200 (e.g., a bar assembly, a chain saw bar, etc.) includes a main portion, shown as body 202 (e.g., a steel portion, a structural portion, etc.) and a second portion, shown as insert 204. The insert 204 may be manufactured from a material different than the material of the body 202. For example, the insert 204 can be manufactured from a material that is lighter than a material of the body 202 (e.g., a less dense material). In some embodiments, the body 202 is manufactured from steel and the insert 204 is manufactured from aluminum or other light weight material. The insert 204 may have an overall length that is greater than 50% of the length of the body 202. In some embodiments, the insert 204 has an overall length that is 50%-90% of the length of the body 202. In some embodiments, the insert 204 has an overall length that is 60-80% of the length of the body 202. In some embodiments, the insert 204 has an overall length that is 80% of the length of the body 202. In some embodiments, the insert 204 has an overall length that is 70% of the length of the guide bar 200. In some embodiments, the insert 204 has an overall length that is 50%-90% of the length of the guide bar 200.

Referring particularly to FIGS. 2-3, the guide bar 200 is shown from a first side in FIG. 2 and a second side in FIG. 3. The guide bar 200 includes a first end 208 that is received within the body 102, and a second end 210 (e.g., a tip) that includes a nose 206 (e.g., including a nose sprocket). The insert 204 extends lengthwise along the guide bar 200 from a position proximate the first end 208 to a position proximate the second end 210. The insert 204 may be provided as a separate component that is inserted into the body 202. The guide bar 200 may therefore be lighter weight than a bar that does not include the insert 204 and is instead manufactured from an integral piece of steel. However, the guide bar 200 is also a unitary component including the insert 204 formed within the body 202. Advantageously, the guide bar 200 provides the benefits of a unitary bar without excessive deflection and having sufficient stiffness while reducing weight by using the insert 204 which is manufactured from a lighter weight material (e.g., aluminum). The insert 204 may be bonded with the body 202 by friction stir extrusion such that the insert 204 and the body 202 form a unitary member. The insert 204 may have a generally straight shape along the length of the body 202 without following a profile of the body 202 in order to reduce complexity associated with manufacturing of the bar 200.

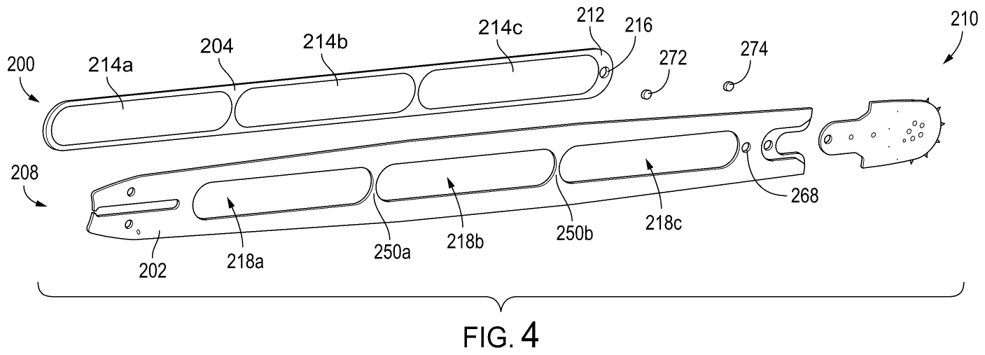

Referring particularly to FIG. 4, the insert 204 includes a main portion 212 that defines a first side and a second side. The second side includes multiple protrusions, shown as protrusions 214a-214c. The protrusions 214a-214c may have rounded edges and can be provided as discrete protrusions along a centerline of the second side of the main portion 212. It should be understood that the protrusions 214a-214c may have any length, shape, or number. For example, the protrusions 214a-214c may be elongated, circular, elliptical, have rounded ends, have square or angled ends, etc., or have any other shape. The main portion 212 also includes an opening 216 resulting from removal a tool for friction stir extrusion when the friction stir extrusion process is completed. The opening 216 is filled with a plug to provide a flush surface in some embodiments.

Referring to FIGS. 4 and 8, the body 202 includes a space 260 configured to receive the insert 204 including a first aperture 220 on the first side (shown in FIG. 2) and multiple second apertures 218a-218c on the second side (shown in FIG. 3). The first aperture 220 corresponds to the main portion 212 of the insert 204 such that the main portion 212 of the insert can be received within and fill the first apertures 220. The first aperture 220 may be a primary opening and can have an elliptical shape. In some embodiments, the first aperture 220 extends a depth approximately one third, approximately one half, or approximately two thirds of a thickness of the body 202. The first aperture 220 extends along a majority of a length of the body 202. The second apertures 218a-218c correspond to the protrusions 214a-214c of the insert 204 and are configured to receive and be filled by the protrusions 214a-214c when the insert 204 is inserted into the body 202. The second apertures 218a-218c may be machined from the first aperture 220 and extend the rest of the way through the thickness of the body 202. The second apertures 218a-218c have a smaller radius than the first aperture 220, according to some embodiments. Similar to the protrusions 214a-214c, the second apertures 218a-218c may have any length, shape, or number, in order to correspond to the protrusions 214a-214c. For example, the second apertures 218a-218c may be elongated, circular, elliptical, have rounded ends, have square or angled ends, etc., or have any other shape. Engagement between the protrusions 214a-214c and the second apertures 218a-218c may lock or limit movement of the insert 204 in a longitudinal direction along the body 202 to improve stiffness of the bar 200.

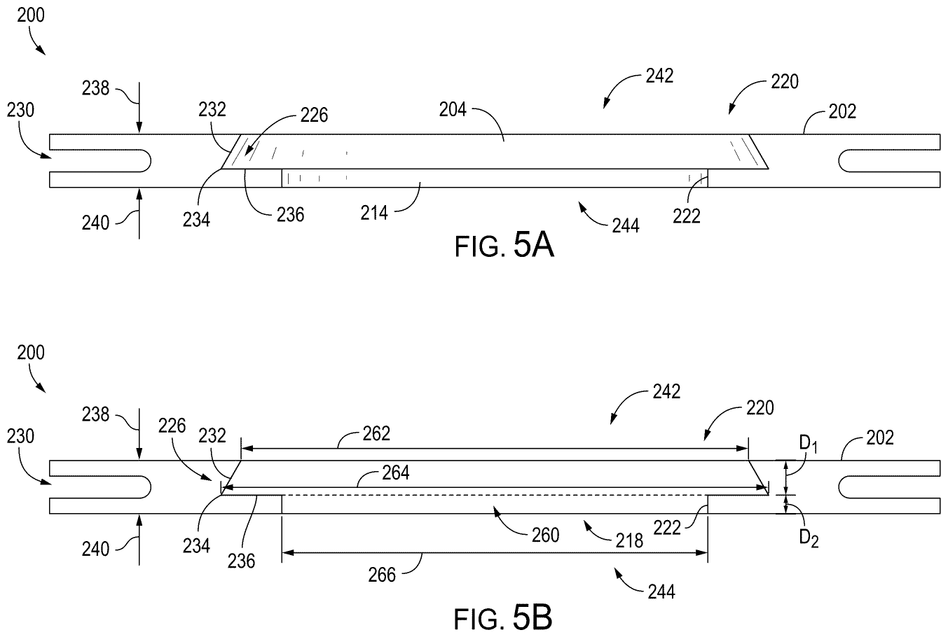

Referring particularly to FIGS. 5A and 8, a sectional view of the body 202 shows the first aperture 220 and one of the second apertures 218. The body 202 includes a dovetail shape 226 (e.g., a dovetail-shaped edge) configured to receive the main portion 212 of the insert 204. The dovetail shape 226 may be machined about a perimeter of the first aperture 220. The dovetail shape 226 includes an angled surface 232 protruding towards an outer edge of the body 202 from an edge 228 of the aperture 220, a corner 234 (e.g., a rounded corner), and a surface 236 that extends towards a center of the body 202. The second apertures 218 defines a through-hole that includes an inner wall 222. The second aperture 218 is configured to receive one of the protrusions 214. The dovetail shape 226 generally defines a recess or groove that extends outwards along a depth of the body 202 towards an outer edge of the body 202 (e.g., towards an outer groove 230 within which the saw chain 106 is received). The dovetail shape 226 defines a periphery, at the corner 234, that is larger than a periphery of the aperture 220 at a first surface 238 of the body 202 on the first side of the body 202. The dovetail shape 226 advantageously provides the angled surface such that, when the insert 204 undergoes friction stir extrusion (or forming from pressing) and substantially fills the dovetail shape 226, the insert 204 is limited from (mechanically prevented from) being removed from the body 202. Accordingly, the dovetail shape 226 retains the insert 204 in the body 202. The surface 236 may extend towards a center of the body 202 and terminate at a location such that it defines a perimeter that is aligned with a perimeter of the second aperture 218 on a second surface 240 of the body 202. The surface 236 and the inner wall 222 may define a shoulder or step. The insert 204 may be inserted into the body 202 from the first side (e.g., first side 242) through the aperture 220 in the first surface 238.

Referring to FIG. 5B, the apertures 220 and 218 define the space 260, as shown from the cross-sectional view. The space 260 may have a first sub-volume defined by the first apertures 220, the dovetail shape 226 along the edges, and the transition between the surfaces 236 and the inner wall 222. The first sub-volume of the space 260 may have a frustoconical shape. A first length 262 is defined by the aperture 220 on the first surface 238 of the body 202. A second length 264 is defined at the corner 234, or more specifically, at the transition between the angled surface 232 and the surfaces 236. The second length 264 is at a depth D1 into the body 202 from the first surface 238 of the body 202. The second length 264 is greater than the first length 262 such that a perimeter of the first sub-volume of the space 260 increases in overall size along the depth of the body 202 from the first side 242 towards a second side 244. The space 260 also includes a second sub-volume defined at the transition between the surfaces 236 and the inner wall 222, the inner walls 222, and the aperture 218 on the second surface 240. The second sub-volume may have a constant length 266 along a depth D2 that represents a remainder of the thickness of the body 202 past the depth D1. In some embodiments, the depth D1 of the first sub-volume is greater than the depth D2 of the second sub-volume. The first sub-volume is configured to receive the main portion 212 of the insert 204 and the second sub-volume(s) are configured to receive the protrusions 214a-214b of the insert 204.

Referring particularly to FIGS. 3, 4, and 7, the body 202 may include a first bridge 250a and a second bridge 250b that are defined between adjacent of the second apertures 218a-218c. In particular, the first bridge 250a is defined between the first aperture 218a and the second aperture 218b. The second bridge 250b is defined between the second aperture 218b and the third aperture 218c. The first bridge 250a and the second bridge 250b are provided as structural portions of the body 202 to provide additional stiffness for the guide bar 200. The engagement between the protrusions 214a-214c and the body 202 within the second apertures 218a-218c functions as a rivet mechanism to mechanically bond to increase stiffness of the body 202 which is reduced due to the removal of steel (e.g., by milling the space 260). The first bridge 250a and the second bridge 250b are configured to facilitate locking the insert 204 with the body 202 in the longitudinal direction along the body 202, thereby increasing stiffness of the bar 200. The dovetail shape 226 facilitates engagement between the body 202 and the insert 204 to limit vertical movement and retain the insert 204 within the body 202. The dovetail shape 226 also improves torque resistance of the bar 200.

Referring to FIGS. 3, 4, and 7, the body 202 may include an tooling hole 268 that aligns with the opening 216. The tooling hole 268 may provide an alignment feature or interface such that, when the guide bar 200 is manufactured, the body 202 may be property aligned with a machine for friction stir extrusion. In some embodiments, the bar 200 includes a tooling crush ball 272 to facilitate friction stir extrusion and manufacturing. In some embodiments, the bar 200 further includes a nose rivet 274 to couple the nose 206 with the body 202.

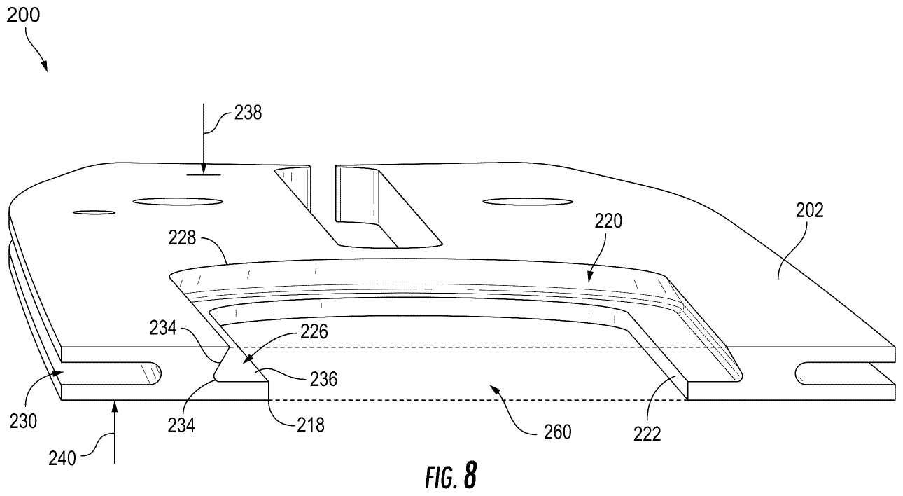

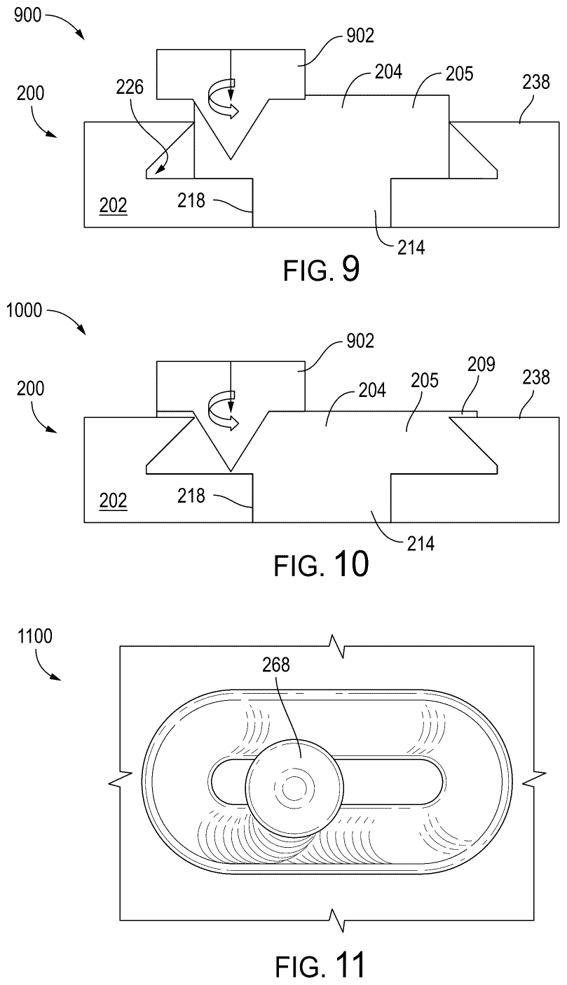

Referring to FIGS. 9-11, diagrams 900, 1000, and 1100 illustrate the manufacturing process of the bar 200 in greater detail, according to some embodiments. The insert 204 may be provided into the space 260 such that the protrusions 214a-214c are received within the second apertures 218a-218c. The insert 204 may include a portion 205 that protrudes upwards beyond the first surface 238. In particular, the insert 204 may have a thickness that is greater than the thickness of the body 202 before fully installed. The portion 205 has a width that is less than the second diameter 264 of the dovetail shape 226, and can be initially rectangular rather than trapezoidal and/or frustoconical as is the negative space provided by the dovetail shape 226 (e.g., the insert 204 having an initial T-shape). The insert 204 may be inserted into the body 202 from the first side 242. The insert 204 then undergoes friction stir extrusion in which a tooling bit 902 exerts a force onto the insert 204 (e.g., at the portion 205) and a torque onto the insert 204. The insert 204 may also be welded, crushed, or formed to the body 202. The tooling bit 902 causes the portion 205 of the insert 204 to extrude outwards to fill spaces around the dovetail shape 226 (i.e., causing a transition from the initial state shown in diagram 900 to the extruded state shown in diagram 1000). The friction stir extrusion process may also cause the insert 204 to form a bond with the body 202 such that the insert 204 and the body 202 form an integral unit. During the friction stir extrusion process, residual portions 209 of the insert 204 that protrude over the top surface 238 may be left. The residual portions 209 of the insert 204 may be machined off after the friction stir extrusion process is completed. Once the tooling bit 902 completes the friction stir extrusion process, the tooling bit 902 may be removed via the tooling hole 268 and the tooling hole 268 can be filled with a plug.

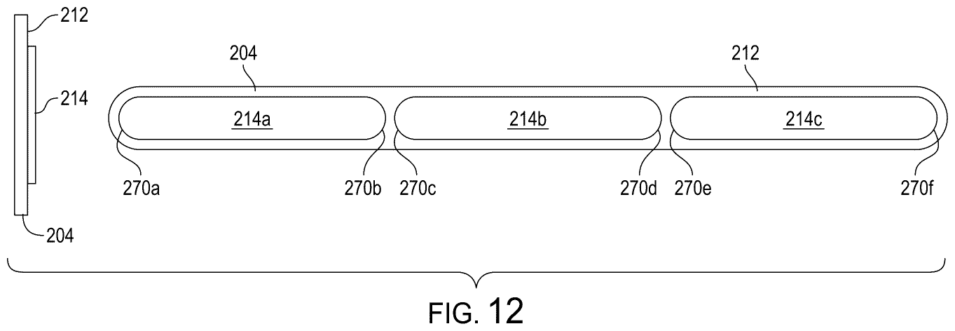

Referring to FIG. 12, the insert 204 may be manufactured by extruding a T-shape profile. The T-shape profile may be defined by the main portion 212 (e.g., the portion 205 before the slit extrusion process is performed) and the protrusions 214. When the insert 204 is extruded in the T-shape, the protrusions 214 may be unitary with each other and form an elongated based of the T-shape. Edges and profiles of the protrusions 214, shown as edges 270a-270f can be machined by removing material from the base of the T-shape to provide the discrete protrusions 214a-214c. It should be understood that any number or length of the protrusions 214 may be machined into the insert 204 as desired by a design for the bar 200. In alternative embodiments, the insert 204 is injection molded or cast directly into the body 202.

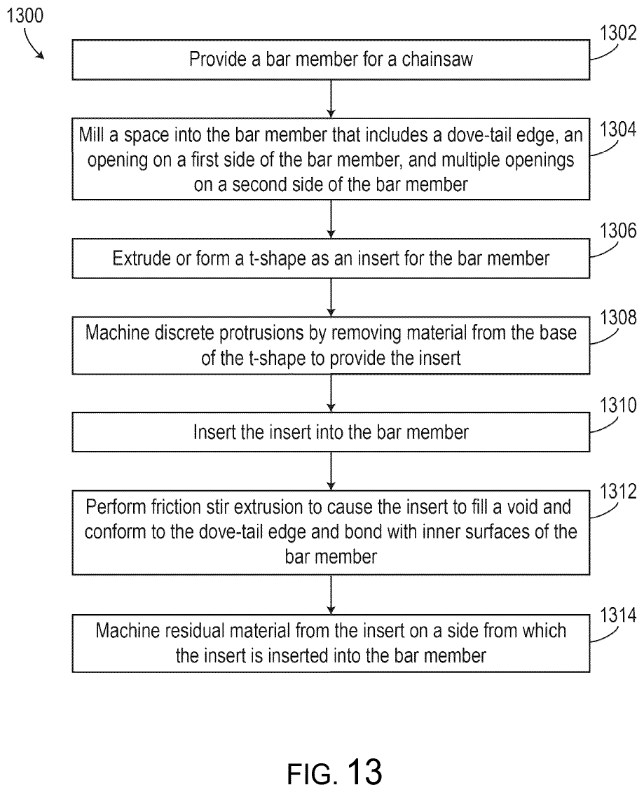

Referring to FIG. 13, a flow diagram of a process 1300 (e.g., a method) for manufacturing the guide bar 200 includes steps 1302-1314, according to some embodiments. The process 1300 may be performed using a variety of manufacturing techniques in order to produce a bar for a chainsaw that includes higher weight and higher strength materials with lower weight materials to provide an integrated bar that has both desirably low weight and sufficient strength without hollow sections or voids (and is therefore a true solid bar), and deflection characteristics.

The process 1300 includes providing a bar member for a chainsaw (step 1302) and milling a space into the bar member that includes a dove-tail edge, an opening on a first side of the bar member, and multiple openings on a second side of the bar member (step 1304), according to some embodiments. The bar member may be forged or machined. In some embodiments, the bar member is manufactured from a steel material. The space in the bar may be milled such that a lateral width of the space increases with increased depth into the bar member to provide the dove-tail edge. The opening on the first side of the bar member may provide an access side such that an insert can be provided into the space from the first side. The space may be the space 260 and may have the geometry as described in greater detail above with reference to FIGS. 2-8.

The process 1300 includes extruding or forming a t-shape as an insert for the bar member (step 1306) and machining discrete protrusions by removing material from the base of the t-shape to provide the insert (step 1308), according to some embodiments. The insert may have a cross-sectional area that is t-shaped. In some embodiments, the base of the t-shape matches in lateral width to widths of the openings on the second side of the bar member. The discrete protrusions may have rounded ends corresponding to rounded ends of the opening on the second side of the bar member. The insert may be the insert 204 as described in greater detail above with reference to FIGS. 2-12. In some embodiments, the insert is taller than a total depth or thickness of the bar member.

The process 1300 includes inserting the insert into the bar member (step 1310) and performing friction stir extrusion to cause the insert to fill in a void and to conform to the dove-tail edge and bond with inner surfaces of the bar member (step 1312), according to some embodiments. In some embodiments, the insert is aligned and placed into the space in the bar member, with the discrete protrusions of the insert being received within the openings on the second side of the bar member. The friction stir extrusion may be performed by using a tooling bit to exert a force onto the insert from the first side of the bar member while providing a torque. The friction stir extrusion causes the material of the insert to be pushed into direct contact with the dove-tail edge and also causes a mechanical bond between the insert and the bar member. The insert may be manufactured from a lighter weight metal such as aluminum. In some embodiments, the insert is injection molded. The friction stir extrusion process may leave residual imperfections or an irregular surface along the insert on the first side of the bar member. The process 1300 includes machining the residual material from the insert on a side from which the insert is inserted (the first side, also the side on which the friction stir extrusion is performed) into the bar member (step 1314). Step 1314 may be performed such that an external surface on the first side of the insert is co-planar with an external surface on the first side of the bar member.

Advantageously, the steps of milling or machining the space into the bar member (step 1304), inserting the insert into the bar member (step 1310) and performing friction stir extrusion (step 1312) may all be performed from a same side of the bar member. This improves manufacturing ease and speed. Providing differently shaped openings on opposite sides of the bar member (e.g., the first aperture 220 and the second apertures 218a-218c) may optimize weight removal of the body 202 while retaining bar stiffness.

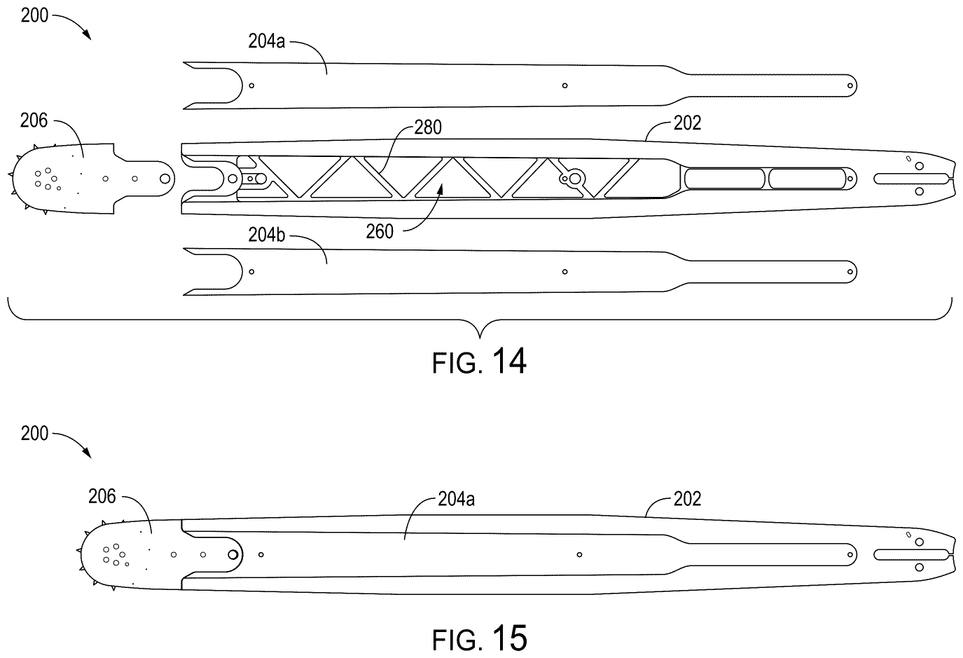

Referring to FIGS. 14 and 15, a first alternative embodiment of the guide bar 200 includes the body 202 having a lattice structure 280 formed in the space 260. The lattice structure 280 may include cross members that extend across the space 260. The lattice structure 280 may also include an opening configured to receive a rivet. The guide bar 200 includes a first insert 204a and a second insert 204b. The first insert 204a and the second insert 204b may be assembled on opposite sides of the body 202 and abut the lattice structure 280. The first insert 204a and the second insert 204b may be riveted or otherwise fastened to the lattice structure 280 and may abut or directly contact opposite sides of the lattice structure 280. In some embodiments, the first insert 204a and the second insert 204b are slid along channels provided in the body 202 on either side of the lattice structure 280 such that the first insert 204a and the second insert 204b are retained by such channels and by the nose 206.

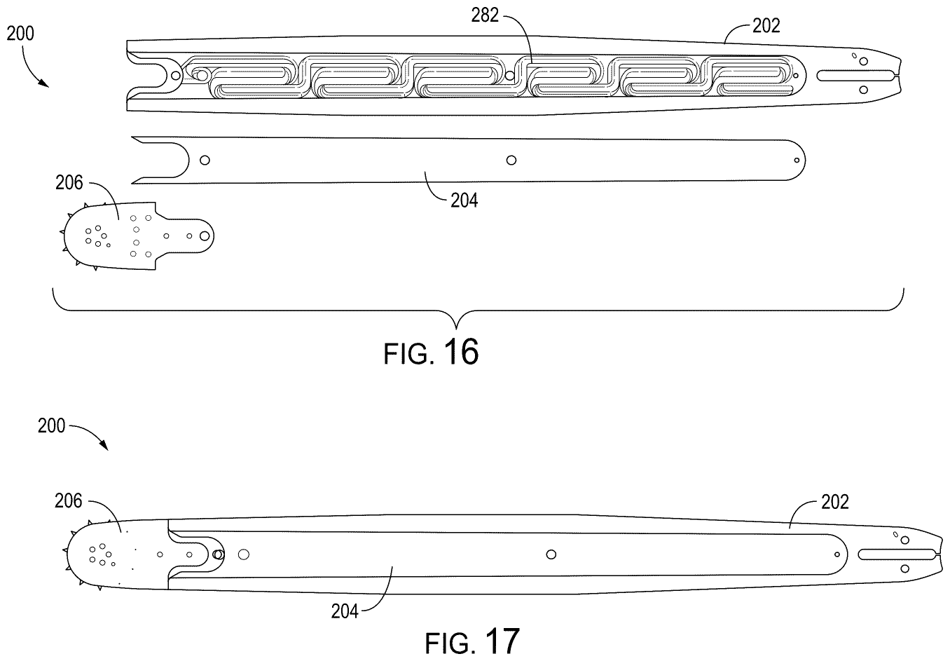

Referring to FIGS. 16 and 17, a second alternative embodiment of the guide bar 200 includes the body 202 having a path of protrusions or recesses, shown as protrusions 282, formed at least one side of the body 202. The guide bar 200 may include the insert 204 configured to be positioned over the protrusions 282. The insert 204 may include recesses corresponding to the protrusions 282 of the body 202 such that when the insert 204 is installed onto the body 202, the recesses and protrusions 282 interlock. In some embodiments, the insert 204 is riveted to the body 202. In some embodiments, the insert 204 is slid along a channel provided in the body 202 on over the protrusions 282 such that the insert 204 is retained in the body 202 by such channel and by the nose 206.

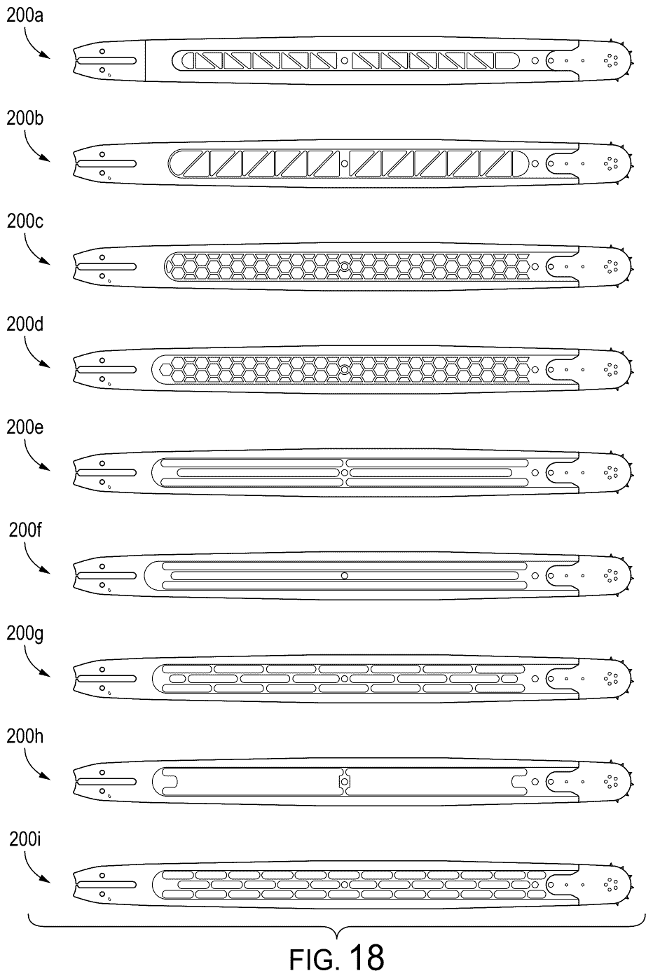

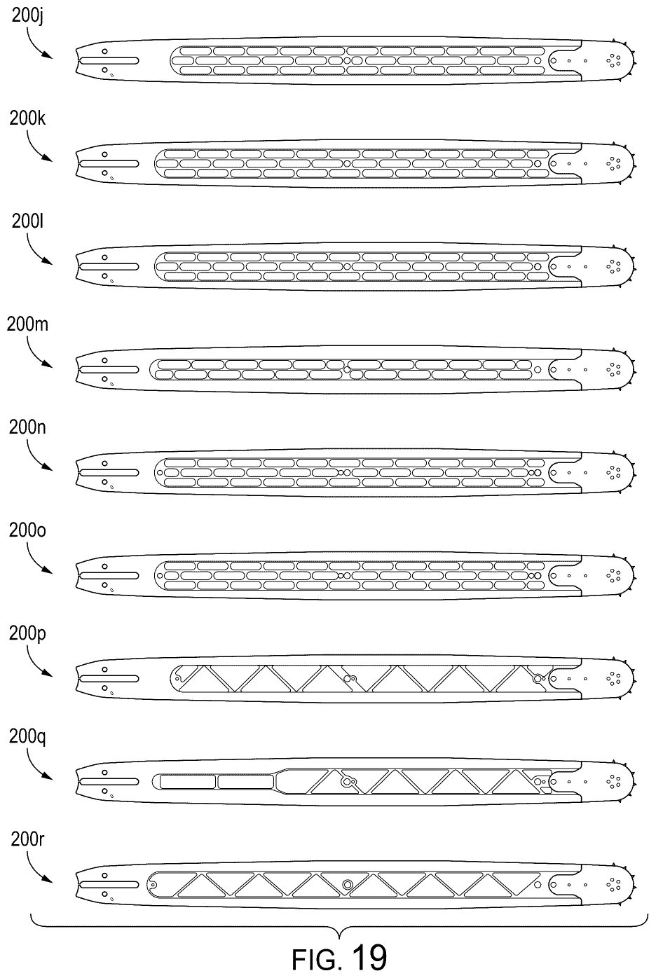

Referring to FIGS. 18 and 19, various alternative embodiments of the guide bar 200 are shown. Any of the embodiments of the guide bar 200 described herein with reference to FIGS. 18 and 19 may be assembled with correspondingly shaped inserts 204. The guide bar 200 may be provided as guide bar 200a including a lattice structure with vertical and angled cross members. The guide bar 200 may be provided as guide bar 200b including a lattice structure with vertical and angled cross members that have a larger cell size and are formed in a larger space than the lattice structure of the guide bar 200a. The guide bar 200 may be provided as guide bar 200c or 200d including a lattice structure formed of polygonal cells having various sizes. The guide bar 200 may be provided as guide bar 200e having lengthwise opening in the space 260. The guide bar 200 may be provided as guide bar 200f having lengthwise recesses or protrusions formed in the side. The guide bar 200 may be provided as guide bar 200g having various rows of openings or cells that are offset from each other. The guide bar 200 may be provided as guide bar 200h having two larger openings. The guide bar 200 may be provided as guide bar 200i including cells or openings that are arranged along rows and offset relative to each other. The guide bar 200 may be provided as guide bar 200j, guide bar 200k, or guide bar 2001 having variously sized cells or openings disposed along three rows. The guide bar 200 may be provided as guide bar 200m having cells or openings disposed along two rows and offset relative to each other. The guide bar 200 may be provided as guide bar 200n or 200o having three rows of cells offset relative to each other according to various patterns. The guide bar 200 may be provided as guide bar 200p or 200q having a lattice structure with angled lattices. The guide bar 200 may be provided as guide bar 200r having various grooves or channels formed in the sides configured to interface with corresponding grooves or channels of the insert 204.

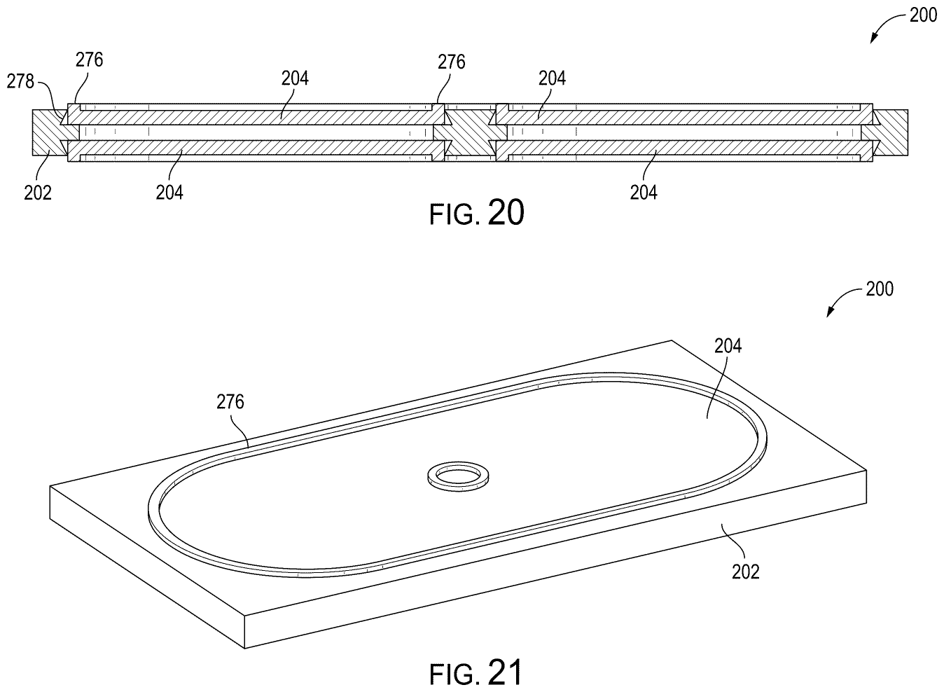

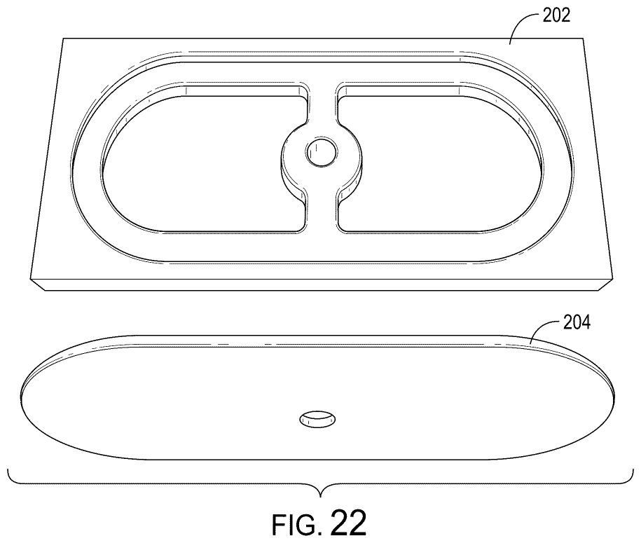

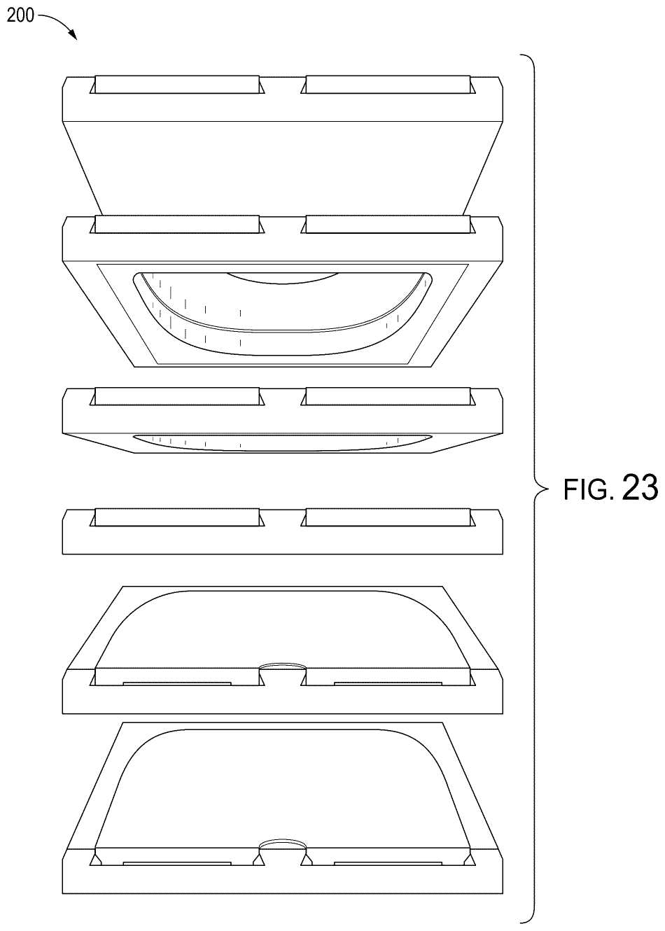

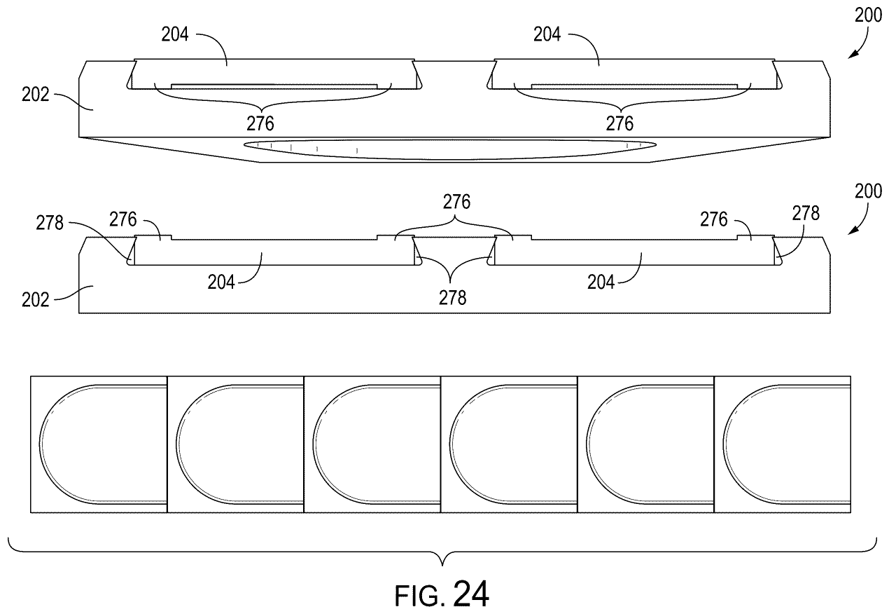

Referring to FIGS. 20-24, the bar 200 may be manufactured by using a pressing or crushing technique instead of friction stir extrusion. As shown in FIGS. 20-24, the insert 204 includes additional material built up along an edge, shown as rim 276. The rim 276 may be inserted such that the rim 276 is received within the body 202, or may be external to the body 202 and protrude outwards from the body 202. The insert 204 may be pressed (e.g., by a press, by hammer, etc.) such that the rim 276 or additional material provided by the rim 276 is crushed and deforms into a void 278 (e.g., the dovetail shape 226). Advantageously, the pressing or crushing technique may provide an easy and simple manufacturing process without requiring advanced tooling operations. In some embodiments, the insert 204 is otherwise pressed or welded into the body 202.

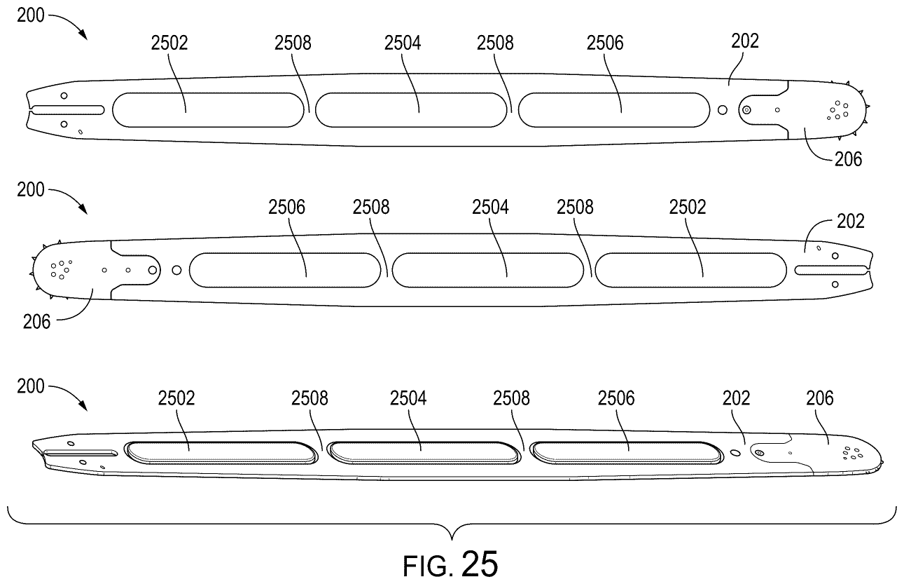

Other implementations using a pressing or crushing technique are shown in FIGS. 25-34. As shown in FIG. 25 in a first side view, a second (opposite) side view, and a perspective view, the guide bar 200 can include the body 202 and inserts (e.g., aluminum inserts), shown as a first insert 2502, a second insert 2504, and a third insert 2506, retained in spaces formed in the body 202. The guide bar 200 also includes a nose 206 (e.g., including a sprocket). The body member 202 can be formed with web portions 2508 arranged between inserts (e.g., between the first insert 2502 and the second insert 2504, and between the second insert 2504 and the third insert 2506) which can contribute to rigidity of the guide bar 200. The inserts 2502, 2504, 2506 can be pill-shaped, rectangular with curved corners or ends, etc. or other shapes in various embodiments. In other embodiments the guide bar includes two inserts, four inserts, five inserts, six inserts, etc.

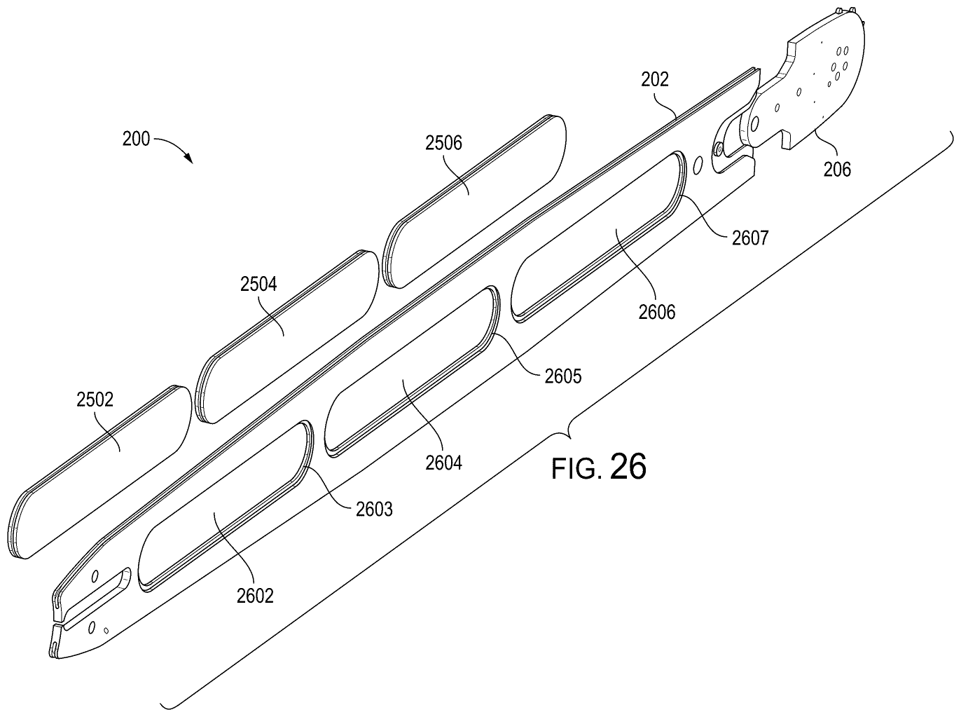

FIG. 26 shows an exploded view of a guide bar 200 consistent with the embodiments of FIG. 25. As shown in FIG. 26, the guide bar 200 includes a first space 2602 defined by a first wall 2603 to receive the first insert 2502, a second space 2604 defined by a second wall 2605 to receive the second insert 2504, and a third space 2606 defined by a third wall 2607 to receive the third insert 2506. The first space 2602 can be created by machining the body 202 to form the first wall 2603 and create the first space 2602 as an aperture (window, hole, etc.) extending through the body 202. The second space 2604 can be created by machining the body 202 to form the second wall 2605 and create the second space 2604 as an aperture (window, hole, etc.) extending through the body 202. The third space 2606 be created by machining the body 202 to form the third wall 2607 and create the third space 2606 as an aperture (window, hole, etc.) extending through the body 202. Such machining can be provided as part of a process of manufacturing the guide bar 200. The inserts 2502, 2504, 2506 can then be inserted into the spaces 2602, 2604, 2606 of the guide bar 200.

FIG. 27 illustrates a cross-sectional view (e.g., cross-sectional end view) of the first insert 2502 received in the first space 2602 of the guide bar 200. As shown, the first space 2602 is defined by the first wall 2603, which extends circumferentially around the first space 2602 as well as across a thickness of the body 202. The first wall 2603 is formed such that a portion of the wall (shown as protrusion 2700) extends into the first space 2602. In the example shown, the protrusion 2700 is substantially centrally located along the thickness of the body 202 and is positioned at least at opposing sides of the space 2502 (e.g., extending entirely around a circumference of the space 2502 or in discrete locations along the wall 2603 in various embodiments).

The first insert 2502 is shown as including a first side 2702 which is substantially flat and arranged such that first side 2702 is flush with and provides smooth transition to a corresponding side of the body 202. The first side 2702 is shown as include an edge 2704 positioned at the first wall 2603 and engaging the protrusion 2700, thereby preventing the first insert 2502 from moving through the first space 2602, at least in an upwards direction from the perspective of FIG. 27.

The first insert 2502 extends as a solid member from the first side 2702 to a second side 2706. A thickness of the first insert 2502 is such that the second side 2706 is flush with and provides smooth transition to a corresponding side of the body 202 (i.e., an opposite side of the body 202 than the side flush with first side 2702 of the first insert 2502). In the state shown in FIG. 27, the second side 2706 includes a raised edge (lip, rim, elevated portion, additional material, etc.) 2708 at a periphery of the second side 2706, while a cavity 2710 remains between the wall 2603 and the second side 2706 (between the wall 2603 and the raised edge 2708).

FIG. 28 illustrates a manufacturing step of deforming the raised edge 2708 into the cavity 2710. Such step can be performed by crushing (e.g., with a press or roller) the raised edge 2708 downward such that the first insert 2502 deforms to fill the cavity 2710 and no longer extends upwards as the raised edge 2708. The material which fills the cavity 2710 can come from the raised edge 2708 and/or a portion of the first insert 2502 proximate the raised edge 2708 and the cavity 2710 and which is forced into the cavity 2710 via crushing of the raised edge 2708. Such crushing, pressing, etc. can be performed such that the cavity 2710 is substantially filled and a flush, continuous surface is provided that spans across the surface of the body 202 and the second side 2706 of the first insert 2502.

As a result of such deformation, the protrusion 2700 becomes positioned between the edge 2704 of the first side 2702 of the first insert 2502 and the edge 2708 of the second side 2706 of the first insert 2502, for example such that the protrusion 2700 is positioned in a peripheral groove, track, recess, slot, etc. of the first insert 2502. Mechanical engagement between the protrusion 2700 and the first insert 2502 thereby retains the first insert 2502 in the first space 2602 and in the body 202 of the guide bar 200.

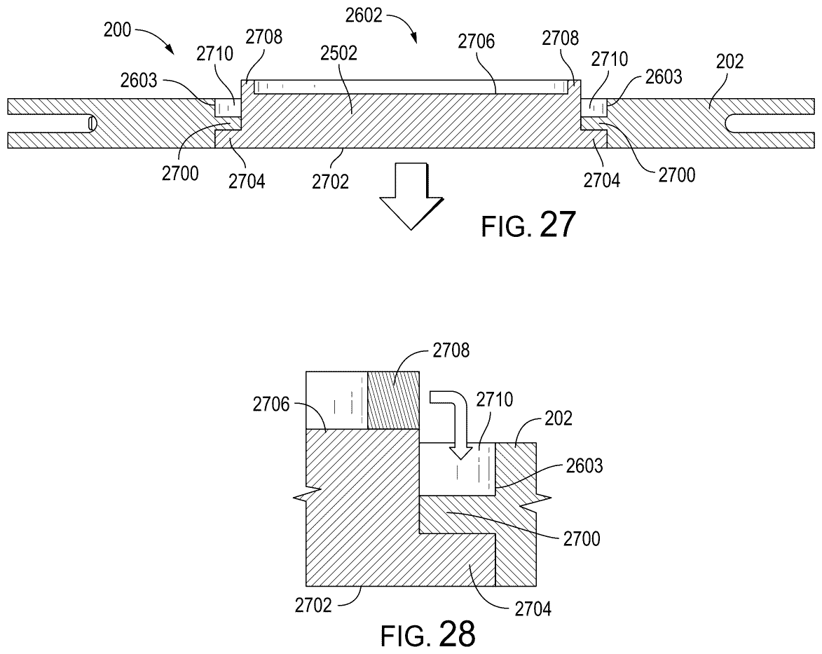

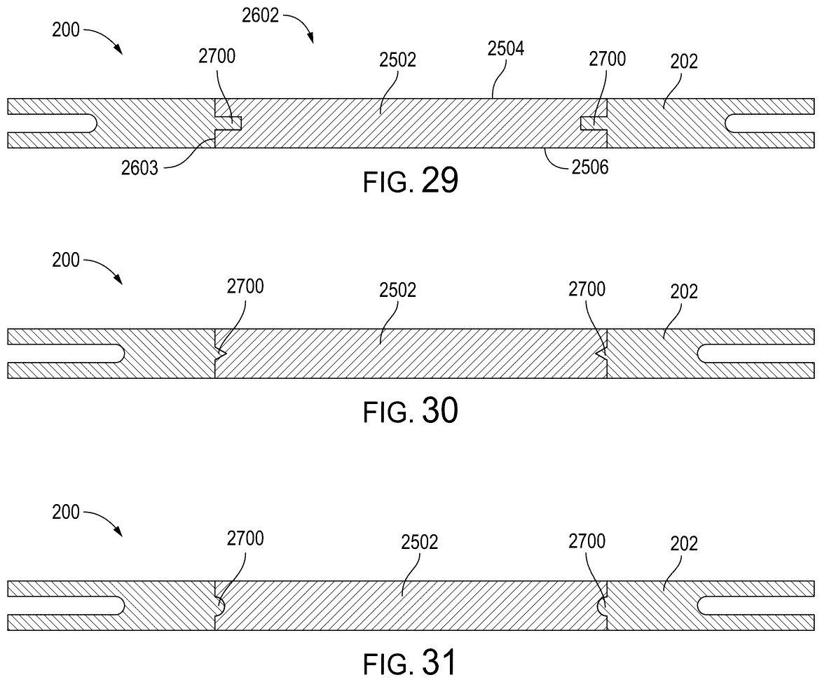

A portion of the guide bar 200 following such crushing, pressing, etc. is shown in FIG. 29. As shown, the protrusion 2700 is captured between the first side 2702 and the second side 2706 of the first insert 2502. The protrusion 2700 is thereby engaged in a peripheral grove, track, recess, slot, etc. of the first insert 2502. Engagement between the protrusion 2700 and the first insert 2502 mechanically retains the first insert 2502 in the first space 2602 (and in the body 202).

Such engagement and retention of the first insert 2502 in the body 202 is achieved without requiring use of an adhesive or chemical bonding between the insert and the body, and without requiring thermal bonding (e.g., welding) or other heat-based technique for bonding metals. For example, crushing, pressing, etc. of the edge 2704 of the first insert 2502 into the cavity 2710 can be performed at room temperature (e.g., below 75 degrees Fahrenheit), which can contribute to ease and efficiency of manufacturing while preserving properties of the body 202 which may otherwise be affected by exposure to heat.

The second insert 2504 and the third insert 2506 can be retained in the second space 2604 and the third space 2606 via crushing of a edge of such inserts in the same or similar manner as for the first insert 2502. In various embodiments, such a process of retaining an insert in a space of a guide bar by crushing of material of the insert can be repeated for (or simultaneously performed for) any number inserts.

In FIG. 29, the protrusion 2700 is shown as having a rectangular cross section, with surfaces protruding orthogonally to a remainder of the wall 2603. The protrusion may have different shapes in different embodiments, for example as illustrated in FIGS. 30-31. As shown in FIG. 30, the protrusion 2700 has a triangular shape from a cross-section view. As shown in FIG. 31, the protrusion 2700 has a semi-circular shape from a cross-section view. Various different shapes or combinations of such shapes can be used for the protrusion 2700 in various embodiments.

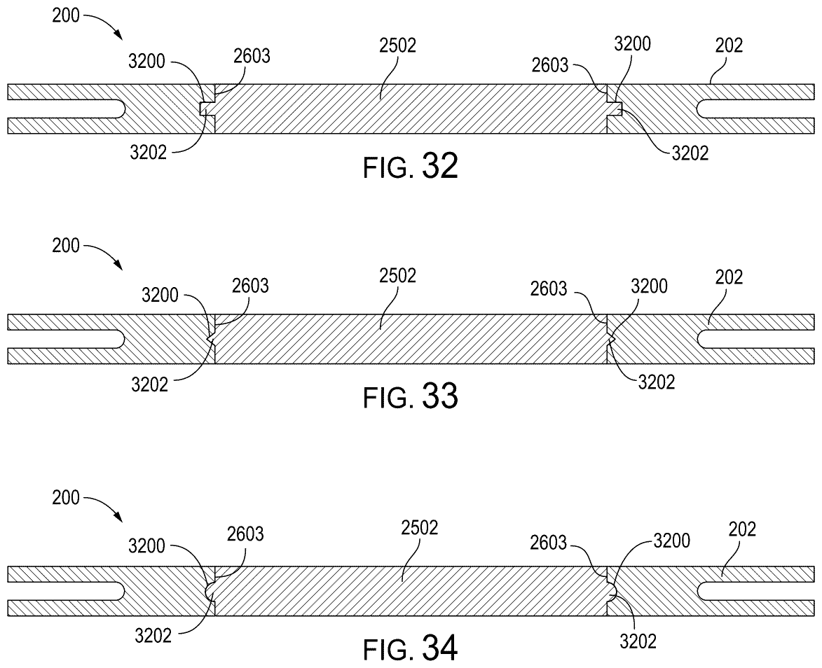

Referring now to FIGS. 32-34, cross-section end views of additional embodiments of a guide bar are shown, according to some embodiments. In the embodiments shown, the wall 2603 includes a recess 3200 rather than the protrusion 2700, and the first insert 2502 includes a protrusion 3202 received within and substantially filing the recess 3200. Engagement between the protrusion 3204 and the recess 3200 mechanically retains the first insert 2502 in the body 202. Similar to the manufacturing steps described above, such engagement can be created by first providing the first insert with material that protrudes beyond a thickness of the body 202 and then crushing the first insert into the body 202 to deform the first insert 2502 to fill the recess 3200 and form a flush surface with a remainder of the body 202. FIGS. 32-34 illustrate that the recess 3200 (and corresponding protrusion 3202) can have different shapes in various embodiments, for example rectangular (FIG. 32), triangular (FIG. 33), or semi-circular (FIG. 34), or any combination of those or other shapes in various embodiments. In some embodiments, the wall 2603 includes both a protrusion and a recess, or multiples thereof, while the insert 2502 includes complementary structures filling the space 2602 and retaining the insert 2502 in the body 202.

Generally referring to the figures, the teachings herein can be adapted for other components of equipment, for example other forestry, landscaping, or agricultural equipment. For example a mower blade (e.g., for a lawn mower, for a rotary cutter) may have a steel body and an aluminum insert to provide a lightweight yet robust blade.

As utilized herein with respect to numerical ranges, the terms “approximately,” “about,” “substantially,” and similar terms generally mean +/-10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

What is claimed is:

1. A guide bar for a chain saw, the guide bar comprising:
a bar member manufactured from a first metal material and having a wall defining a space in the bar member, wherein a portion of the wall protrudes into the space; and
an insert manufactured from a second metal material, the insert mechanically retained within the space and by engagement between the insert and the portion of the wall protruding into the space.

2. The guide bar of claim 1, wherein the first metal material is steel and the second metal material is aluminum and wherein the aluminum substantially fills the space in the bar member such that the guide bar is a solid metal body.

3. The guide bar of claim 2, comprising a plurality of additional inserts substantially filling a plurality of additional spaces in the bar member.

4. The guide bar of claim 3, wherein the bar member comprises web portions extending between the space and the plurality of additional spaces in the bar member to increase rigidity of the guide bar.

5. The guide bar of claim 1, wherein the portion of the wall protruding into the space is positioned at a surface of the bar member and provides the space with a dove-tail shaped edge.

6. The guide bar of claim 1, wherein the portion of the wall protruding into the space is centrally positioned along a thickness of the bar member.

7. The guide bar of claim 6, wherein:
the insert comprises:
a first side aligned with a first side of the bar member; and
a second side aligned with the second bar member; and
the portion of the wall is positioned between the first side and the second side thereby providing the engagement between the insert and the portion of the wall.

8. The guide bar of claim 7, wherein the insert is a solid body comprising a peripheral groove or slot receiving the portion of the wall between the first side and the second side.

9. A chainsaw comprising:
a body including a motor;
a chain configured to be driven by the motor; and
a bar coupled with the body and configured to receive the chain about an outer periphery of the bar, the bar comprising:
a body member manufactured from steel, the body member comprising a space that differs in size at different depths into the body member; and
an insert manufactured from aluminum, the insert positioned in the space such that the insert substantially fills the space and is mechanically retained in the body member.

10. The chainsaw of claim 9, wherein the space differs in size at different depths into the body member because a portion of a wall defining the space protrudes into the space, the insert mechanically retained in the body member via engagement with the portion.

11. The chainsaw of claim 10, wherein the portion is centrally located along a thickness of the body member, the space extending through the thickness of the body member.

12. A method of manufacturing a bar for a chainsaw, the method comprising:
milling a space in a bar member of a first metal material such that a portion of a wall defining the space in the bar member protrudes into the space;
inserting an insert of a second metal material into the space in the bar member; and
retaining the insert in the space by deforming the insert to cause the insert to engage the portion of the wall protruding into the space.

13. The method of claim 12, wherein deforming the insert comprises crushing a lip of the insert into the space.

14. The method of claim 13, wherein crushing the lip of the insert into the space causes the lip to overlap the portion of the wall protruding into the space and such that the portion of the wall protruding into the space is held between the lip and an opposing side of the insert.

15. The method of claim 12, wherein deforming the insert to cause the insert to engage the portion of the wall protruding into the space comprises causing the insert to substantially fill the space.

16. The method of claim 12, wherein milling the space in the bar member comprises centrally locating the portion protruding into the space along a thickness of the bar member.

17. The method of claim 12, further comprising machining residual material from the insert to provide a smooth transition between the insert and the bar member.

18. The method of claim 12, comprising:
milling an additional space in the bar such that the bar member comprises a web portion extending between the space and the additional space; and
deforming an additional insert into the additional space to substantially fill the additional space and such that the additional insert is retained in the additional space.

19. The method of claim 12, wherein the first metal material is steel and the second metal material is aluminum.

20. The method of claim 12, wherein deforming the insert to cause the insert to engage the portion of the wall protruding into the space comprises performing friction stir extrusion.
